(19) United States
(12) Patent Application Publication
(10) Pub. No.: US 2002/0007369 A1
(43) Pub. Date: Jan. 17, 2002

(54) Network navigation

(76) Inventor: Thiagarajan Saravanan, Westborough, MA (US)

Correspondence Address: DAVID L. FEIGENBAUM, Fish & Richardson P.C., 225 Franklin Street, Boston, MA, 02110-2804, US

(21) Appl. No.: 09/739,171

(22) Filed: Dec. 18, 2000

Related U.S. Application Data
(60) Provisional application No. 60/172,312, filed on Dec. 17, 1999.

(51) Int. Cl. G06F 17/30; G06F 17/21

(52) U.S. Cl. 707/501.1

(57) ABSTRACT

Network navigation includes receiving page instructions for displaying a first web page, the page instructions including application instructions for displaying an application on the first web page, storing the application instructions, receiving new page instructions for displaying a second web page, determining if the second web page includes the application, and formatting the second web page for display based on the new page instructions and, if the second web page includes the application, on the application instructions.

### CROSS-REFERENCE TO RELATED APPLICATIONS

This application claims priority under 35 USC §119 to U.S. provisional application 60/172,312, “NETWORK NAVIGATION,” filed Dec. 17, 1999.

### BACKGROUND

This invention relates to network navigation.

A client can communicate with a network such as a private network, a public network, the World Wide Web, or the Internet through communication links. Depending on factors such as the network browsing system and equipment used by the client, the resources the client accesses on the network, and the communication links used to transmit the resources to the client, the client may experience delay or failure in receiving the resources. Similarly, the client may repeatedly request the same resources in different network requests and experience the delay or failure with each request.

### SUMMARY

According to an aspect of the present invention, network navigation includes receiving page instructions for displaying a first web page, the page instructions including application instructions for displaying an application on the first web page, storing the application instructions, receiving new page instructions for displaying a second web page, determining if the second web page includes the application, and formatting the second web page for display based on the new page instructions and, if the second web page includes the application, on the application instructions.

Implementations of the invention may include one or more of the following features. The application instructions may include object-oriented instructions. The page instructions may include instructions in a Java-based language. The new page instructions may not include data included on the application if the second web page includes the application. The only instructions regarding the application that are included in the new page instructions may include formatting instructions for the application if the second web page includes the application. The application may include a frame.

According to another aspect of the present invention, an apparatus includes a first mechanism configured to store instructions regarding a frame included on a web page and a second mechanism configured to determine if another web page includes the frame, and if so, to format the other web page for display using the instructions.

Implementations of the invention may include one or more of the following features. The apparatus may also include a second mechanism configured to display the web page. The second mechanism may include a web browser. The instructions may include object-oriented instructions. The first mechanism may include computer memory. Instructions sent from a location remote to the first mechanism may instruct the first mechanism to store the instructions. The apparatus may also include comprising a computer including the first mechanism and the second mechanism. The frame instructions may include object-oriented instructions. The page instructions may include instructions in a Java-based language.

According to another aspect of the present invention, an apparatus includes a server configured to communicate with a network, a first mechanism accessible by the server and configured to host page instructions regarding a first web page, the page instructions including data instructions regarding data included on the first web page and including frame instructions regarding a frame included on the first web page, and a second mechanism accessible by the server and configured to host an application including the page instructions for transmission to a destination on the network.

Implementations of the invention may include one or more of the following features. The frame instructions may include modification instructions regarding how to modify the frame from stored instructions included at the destination. The page instructions may include object-oriented instructions. The page instructions may include instructions in a Java-based language. The network may include an Internet.

According to another aspect of the present invention, a system includes a first device configured to communicate with a network, a second device configured to communicate with the network, a first mechanism configured to communicate with the second device and to host page instructions regarding a first web page hosted by the second device, the page instructions including frame instructions regarding a frame included on the first web page, a second mechanism configured to communicate with the first device and to store the frame instructions, a third device configured to communicate with the network and to host second page instructions regarding a second web page hosted by the third device, the second page instructions including second frame instructions regarding the frame, and a third mechanism configured to communicate with the first device and to format the second web page using the frame instructions and the second frame instructions.

Implementations of the invention may include one or more of the following features. The only instructions regarding the frame that are included in the second frame instructions may include alterations to be made to the frame instructions. The frame instructions may include object-oriented instructions. The frame instructions may include instructions in a Java-based language. The first device may include a computer device. The second device and the third device may each include a server device. The network may include an Internet.

According to another aspect of the present invention, network navigation includes receiving page instructions from a first host, the page instructions including frame instructions regarding a frame included on a first web page, storing the frame instructions, requesting a second web page from a second host associated with the first host, receiving format instructions from the second host, the format instructions including instructions regarding a second web page, determining if the second web page includes the frame, and formatting the second web page using the format instructions and, if the second web page includes the frame, the frame instructions.

Implementations of the invention may include one or more of the following features. The page instructions may also include data for the first web page. The format instructions may include data for the second web page. The format instructions may include new frame instructions regarding a new frame included on the second web page. The format instructions may include instructions regarding modifying the frame from the frame instructions. Network navigation may also include requesting the first web page from the first host. The first host and the second host may each include a server device. The frame instructions may include object-oriented instructions. The frame instructions may include instructions in a Java-based language.

One or more of the following advantages may be provided by one or more aspects of the invention.

A user may request from a source a web page including one or more applications. The applications may reside on one or more servers associated with the source. A navigational object provided by the source can speedily and seamlessly integrate the applications from all of the servers. In this way, a company (the source) including a number of subsidiaries, partner companies, internal departments, and other semi-autonomous or autonomous groups can maintain different servers for each one of or for collections of the different groups and easily integrate the applications from each of the servers while providing the web page to the user. Thus, each of the groups can alter or add to its applications without necessitating alterations or additions to other applications residing on other ones of the source's servers.

The navigational object can also be used to customize the services and the functions available to the user. It may be difficult to provide a simple site map on a web page provided to the user to help the user navigate through the services and the functions, especially because of the dynamic nature of the navigational possibilities. To further complicate matters, one of the source's groups may want to have the flexibility to change various aspects of the look and feel of one of its applications at one of the source's servers without requiring a huge amount of development effort. Separating the navigational aspects of the application from the underlying services and functions of the application can help ease the group's development efforts.

The navigational object can also be used to reduce slowness in retrieving frames for use on a web page provided by a source and requested by a user. The web page may include multiple frames, each of which typically requires a round-trip request by the user's browser to the server providing the web page. Additionally, there may be a number of interdependencies of information displayed between the frames. For example, a plan list frame may first need to be displayed so the user can select a plan, and then additional frames specific to the selected plan may need to be retrieved from the server. All of this serialized network activity can result in great delays for the user. The navigational object can be used to cache information at the user to avoid or reduce network round-trips and, wherever possible, to allow the gathering of information for multiple frames with one network request.

Other advantages and features will become apparent from the following description and from the claims.

### DESCRIPTION OF DRAWINGS

FIG. 1 is a diagram of a network configuration.

FIG. 2 is a diagram of a web page.

FIG. 3 is a diagram of a navigation system.

FIG. 4 is a flowchart showing a process of using the navigation system of FIG. 3.

FIG. 5 is a diagram of a login web page.

FIGS. 6-9 are diagrams of web pages.

FIG. 10 is a diagram of a network configuration.

FIG. 11 is a diagram of a web page.

### DETAILED DESCRIPTION

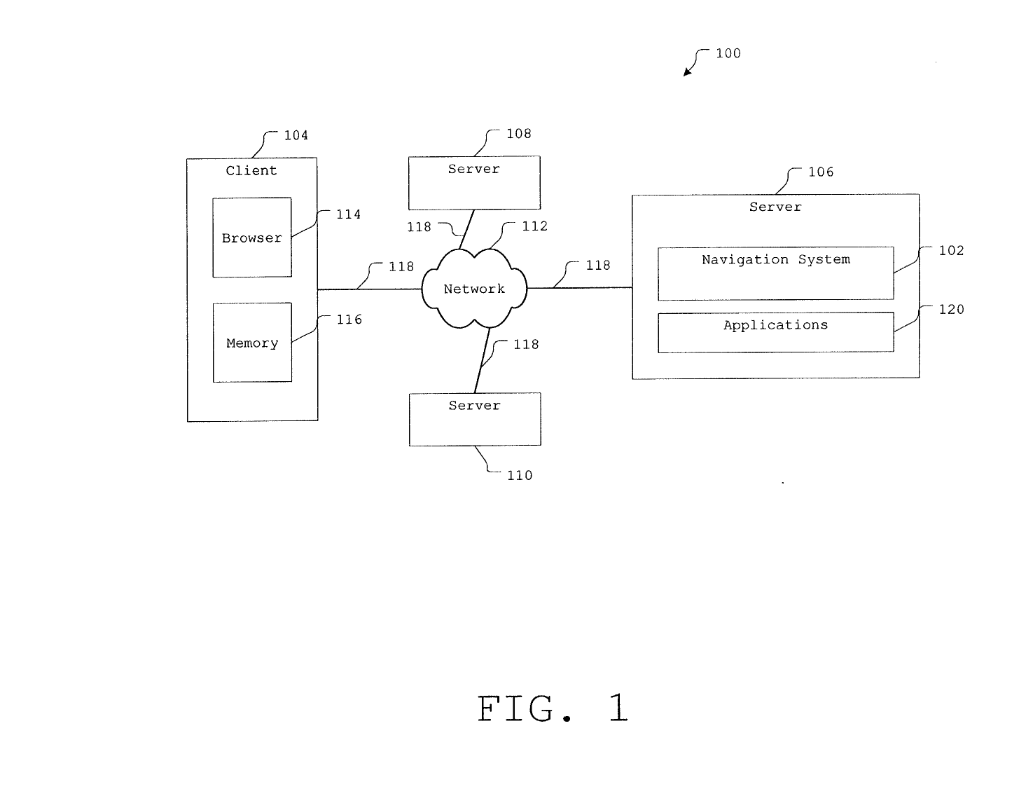

Referring to FIG. 1, a network configuration 100 includes a navigation mechanism 102 that enables a client 104 to integrate applications 120 residing on one or more servers 106, 108, and 110. For simplicity in this example, the applications 120 are assumed to reside only on one server 106. The navigation mechanism 102 provides a programmatic framework that can make the applications 120 distributed from the server 106 and across a network 112 to the client 104 appear more like a cohesive application on a browser 114 at the client 104. The client 104 can cache elements of the applications in a memory 116, thereby reducing the amount of data that the server 106 may need to send in transmitting different applications 120. The applications 120 can include any number of resources capable of being transmitted over the network 112 and over communication links 118 such as web pages accessible through a uniform resource locator (URL) or other address, programs, and other similar “web-entities.” Application instructions and/or data from the navigation mechanism 102 can be transmitted (e.g., downloaded) to the browser 114 when a user at the client 104 visits a web page or accesses a program or other web entity. Appendix A includes an example of the application instructions that the navigation mechanism 102 may use and/or transmit to the client 104.

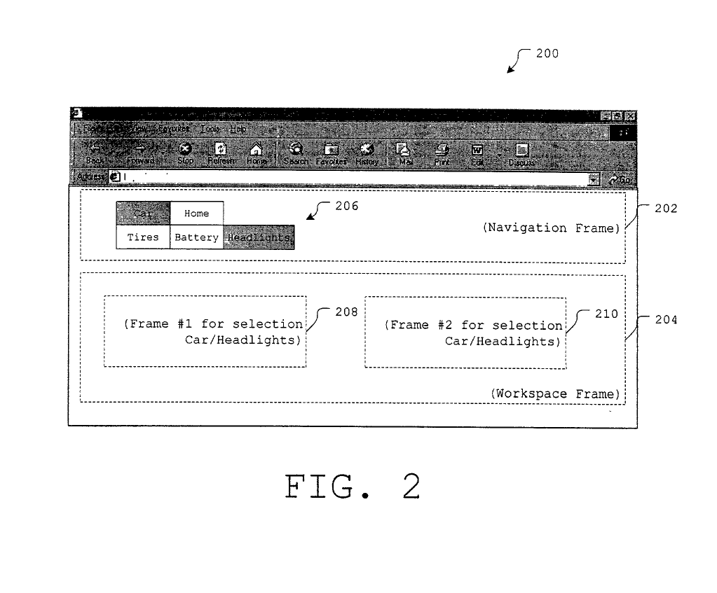

For example, referring to FIG. 2, the navigation mechanism 102 can divide a web display page 200 into multiple frames such as a navigation frame 202 and a workspace frame 204. The navigation frame 202 can include a display of different menu options 206 (also called menu items). The menu options 206 can correspond to different menu URLs, programs, and other similar web entities. Behavior of a menu option 206 when selected (e.g., by touching a menu option 206 via a touch screen, by clicking on a menu option 206 using a mouse, etc.) can be programmatically controlled by the navigation mechanism 102. Additionally, other attributes of the menu options 206 can be programmed, for example, to change the appearance of the menu option 206. The selected menu options 206 in this example are the shaded menu options 206 labeled “car” and “headlights,” although selected menu options 206 need not be shaded or otherwise highlighted. The menu options 206 can also be added or removed from the navigation frame 202 based on programmed instructions downloaded to the client 104 as a user at the client 104 “surfs” to different web sites provided by the server 106 or associated with the server 106 (e.g., the servers 108 and 110).

Generally, frames are individual windows that separate a web display page into multiple, scrollable windows. Each frame may be associated with a particular URL or set of URLs. When the client 104 requests and receives a frame in response to one URL request, the navigation mechanism 102 can directly cache or direct the client 104 to cache the frame in the memory 116 (e.g., by transmitting a program, applet, or other instructions to the client 104). When the client 104 requests another web page using that same frame from the server 106, the server 106 need not retransmit the frame to the client 104; the client 104 can retrieve the frame from the memory 116. If the frame needs to change size, color, or other attribute, the server 106 can transmit instructions regarding those attribute changes rather than the entire frame. In this way, less data need be transmitted to the client 104, thereby reducing the chances of losing data en route to the client 104, decreasing traffic on the communication links 118, and enabling the client 104 to more quickly display the other web page.

For example, the navigation frame 202 and/or the workspace frame 204 may include static information that should always be provided to the user such as top-level menu options, control bars, the current date, the current time, legal notices, corporate icons, user name, and other similar information. Regardless of the menu options 206 chosen by the user, this static information may need to be presented in the navigation frame 202 and/or the workspace frame 204. The browser 114 can display this static information as retrieved from the memory 116 and altered per any navigation instructions received from the server 106.

An important attribute associated with each of the different menu options 206 are frames 208 and 210 included in the workspace frame 204. (Two frames are shown but the workspace frame 204 may include any number of frames for any given subset of selected menu options 206.) By storing frame information on the client side at the memory 116, frame information does not have to downloaded from the server 106 again and again when a user at the client 104 requests the applications 120 and visits and revisits a web site provided by, or associated with, the server 106. Each of the frames 208 and 210 may be associated with a different URL, program, etc. and can present different information such as text, graphics, URL links, data entry boxes, and other similar information. The frames 208 and 210 reflect information for the selected menu options 206. In this example, the frames 208 and 210 show information for the selected “car” and “headlights” menu options 206.

In another example, the navigation mechanism 102 can include instructions for efficiently handling different “browser” events. For example, the navigation mechanism 102 can handle redrawing the contents of the web display page 200 when a user at the client 104 resizes or refreshes the web display page 200 instead of involving a remote server such as the server 106.

The client 104 can include any device capable of connecting to the network 112 and communicating with the server 106 across the network 112, such as a mobile computer, a stationary computer, a server, a personal digital assistant, a telephone, a watch, a pager, or other similar device. The memory 116 can be structured in any way and may include data of different structures. For example, the memory 116 could be structured as or included in random access memory (RAM) or be structured as a database organized using a database management system, a relational database, a hypertext database, a distributed database, or other similar data structure. The memory 116 may be included as part of the browser 114. The browser 114 can be any application able to display and/or execute applications such as web pages, media files, and programs accessed through the network 112, such as Netscape Navigator® Microsoft® Internet Explorer, and other similar applications.

The servers 106, 108, and 110 can include any device capable of connecting to the network 112 such as a file server, a mobile computer, a stationary computer, or other similar device. The network 112 can include any kind and any combination of networks such as the Internet, a local network, a private network, a public network, or other similar network. The communication links 118 can be any kind and any combination of communication links such as modem links, cables, point-to-point links, infrared connections, fiber optic links, cellular links, Bluetooth, satellite links, or other similar links. The client 104 and the servers 106, 108, and 110 may be remotely located from each other, capable of communicating only across the network 112 using the communication links 118. (The network configuration 100 is simplified for ease of explanation; the network configuration 100 may include additional elements such as networks, communication links, servers, proxy servers, firewalls or other security mechanisms, Internet Service Providers (ISPs), and other elements.)

The navigation mechanism 102 can be included on the server 106 as shown (e.g., as a stand-alone application or as part of another application) or otherwise be accessible to the server 106 (e.g., be included on a network accessible by the server 106).

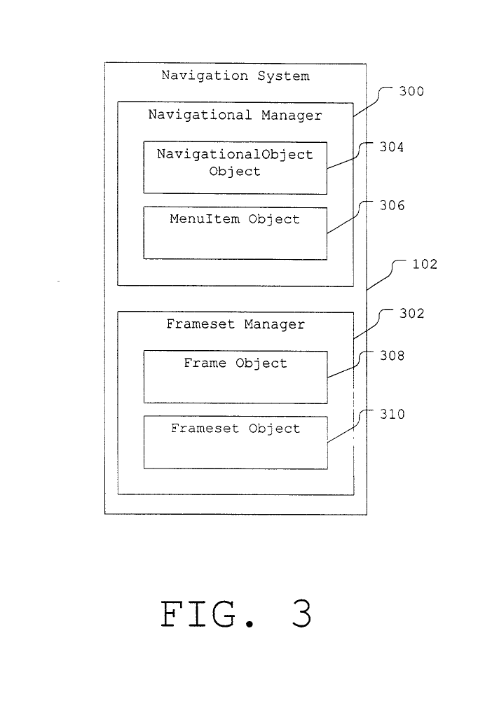

Referring to FIG. 3, the navigation mechanism 102 is shown in more detail. The navigation mechanism 102 includes a navigational manager 300 and a frameset manager 302. Generally, the navigational manager 300 manages navigational elements such as the menu options 206 in the navigation frame 202 (see FIG. 2). For example, when the server 106 sends a hypertext markup language (HTML) page to the browser 114, a server-side application 120 could register with client-side framework information included in the memory 116 such as menu options that the HTML page supports and what actions should occur when a user at the client 104 clicks on one of the menu options 206.

Generally, the frameset manager 302 caches framesets on the client 104, typically in the memory 116. For example, very often when a user at the client 104 clicks on a menu option 206, the browser 114 makes a request that would fetch a frameset from the server 106 including three or more frames. In such a case, the browser 114 would request a minimum of four network round-trips before the browser 114 could display complete frame information in the workspace frame 204 for the request. By caching the framesets at the memory 116, the browser 114 can instead receive one set of instructions from the server 106 as to which cached framesets to display, and therefore be able to display complete frame information after as few as one network round-trip.

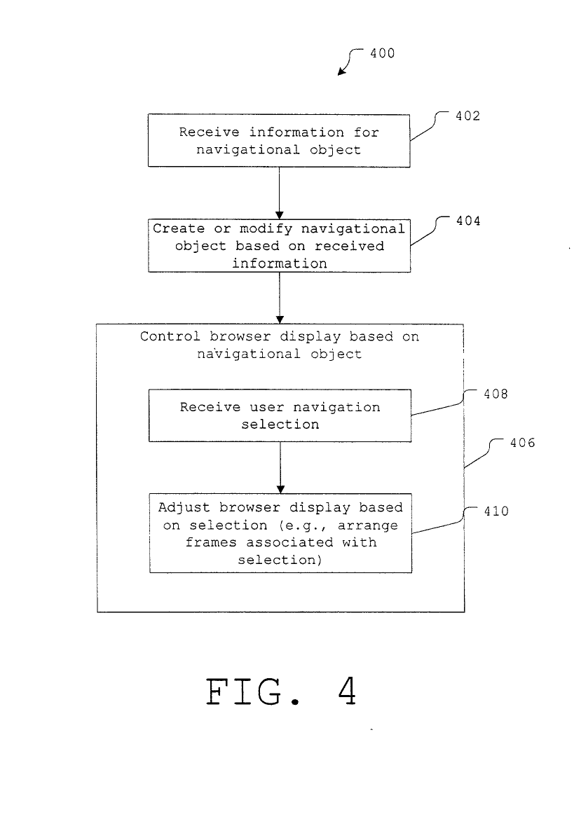

Referring to FIG. 4, a process 400 illustrates an example of providing a browser display to a user while using the navigation mechanism 102. The server 106, at the navigation mechanism 102, receives 402 information for a navigational object. The navigation mechanism 102 creates or modifies 404 the navigational object based on the received information. The navigation mechanism 102 can then control 406 the browser display based on the navigational object. When the navigation mechanism 102 receives 408 a navigation selection from the user, the navigation mechanism 102 can adjust 410 the browser display based on the navigation selection. This adjustment can include arranging frames associated with the navigation selection on the browser display, changing the size or color of the frames on the browser display, and other similar adjustments.

More specifically, referring back to FIG. 3, the navigational manager 300 includes two objects that help manage navigational elements: a NavigationalObject object (navigation object) 304 and a MenuItem object (menu object) 306. Each of the objects 304 and 306 are further described below in turn. Note that an object generally refers to an item including both data and executable functions and/or instructions. An object usually can be individually displayed, manipulated, and/or selected, including elements displayed on the browser 114 and software elements used to display elements on the browser 114.

The navigation object 304 is included in the top-level window of a browser-based application, e.g., the first, introductory web page that a user may encounter in accessing a web site at a particular address (e.g., a URL) through the server 106. This top-level window defines two frames: the navigation frame 202 and the workspace frame 204 (see FIG. 2).

The client 104 executes one navigation object 304 for the web site accessed through the server 106 (e.g., one navigation object for all of the web pages related to a particular URL accessed through the server 106). An example of code that the client 104 may store in the memory 116 and use to execute the navigation object 304 is:

```
// create Navigation Object
new top.Navigationabject (“psw”, //application name)
      ‘navigation’, //containing frame name
      ‘workarea’, //work area frame name
      30, //first menu level height in pixels
      25, //second menu level height in pixels
      25, //third menu level height in pixels
      25, //fourth menu level height in pixels
      25, //fifth menu level height in pixels
```

This sample code creates a five-level navigation object for an application called “PSW.” The navigational elements (e.g., the menu options 206) can be displayed in the navigation frame 202 (see FIG. 2). When a user clicks on or otherwise accesses one of these navigational elements, the result of the request can be put into the workspace (“workarea”) frame 204. Upon construction,. the navigation object attaches itself as the ₁₃ NavObj property of the top-level window. Therefore, the navigation object can be referenced anywhere in the application as top._NavObj.

The following table provides examples of properties and methods of the navigation object 304. The variables (if any) in parentheses after a property or method indicate parameters that may be needed to realize or to execute the property or method.

| Property or Method | Description |
|---|---|
| root | Read-only property that identifies the |
| | topmost level menu entry to which new |
| | MenuItem objects can be attached |
| click (name) | simulates a click event on MenuItem name |
| getItem (name) | retrieves the MenuItem name |
| getFrame (name) | returns the frame object of name |
| getState (name) | retrieves the state associated with the |
| | MenuItem name |
| refresh | redisplays the navigational elements in |
| | the navigation frame (typically used after |
| | changing the visible property of a |
| | MenuItem or after adding new menu items) |
| register (URL) | registers a web page at the URL with the |
| | navigation object which allows the |
| | navigation object to synchronize itself |
| | whenever a user clicks on a back button to |
| | access a previous web page (typically |
| | included in each callable web page, i.e., |
| | in each web page that has its URL declared |
| | in an AddItem call) |
| setCurrentItem | redisplays the navigational elements in |
| (name) | the navigation frame (typically used after |
| | changing the visible property of a |
| | MenuItem or after adding new menu items) |
| setItemVisible | changes visibility of MenuItem item to |
| (item, visible) | visibility status visible, where visible |
| | equals Boolean value indicating visibility |
| setLocation | changes the URL of the location object |
| (target, URL) | associated with a frame, where target |
| | equals the name of the containing frame |
| | and URL equals the new URL |
| setMenuBar (level, | sets the menu bar including the menu |
| color, colorover, | options, where level equals the level |
| image, imageover, | number of the menu level (starts at zero), |
| align, active, | color equals background color of the menu |
| inactive, over, | bar (null if no color), colorover equals |
| activeover, | mouseover color background, align equals |
| inactiveover, | alignment of items in the menu bar (left, |
| text) | right, center, etc.), active equals the |
| | background color when menu item is |
| | selected state, and inactive equals the |
| | background color when menu item is in |
| | non-selected state |
| show | displays the navigation elements in the |
| | navigation frame |
| waitForAndCall | calls a function included in an already |
| (target, function, | loaded page after ensuring that another |
| retries) | page is fully loaded, where target equals |
| | a comma-separated list of names of frames |
| | to be loaded, function equals the function |
| | to call after named frames are loaded, and |
| | retries equals the number of time |
| | intervals (e.g., X second, Y milliseconds, |
| | etc.) to wait before giving up on frames |
| | to load |

The navigation object 304 can include one or more menu bars. Each menu bar includes one or more menu items (options). The navigation object 304 has a root property referencing the topmost menu object 306 to which all first-level menu items are attached. A call to addItem returns a reference to the menu object 306. The following table provides examples of properties and methods of the menu object 306:

| Property or Method | Description |
|---|---|
| state | property set to any object with its own |
| | property and methods that gives |
| | application-specific features to that menu |
| | item |
| URL | includes the URL of a clickable item (can |
| | be read and/or write) |
| addFrameset (type, | associates a frameset with this menu item, |
| target) | superceding any previous URL, where type |
| | equals “rows” or “columns” to indicate the |
| | way that frames are arranged in the |
| | frameset and target (optionally) equals |
| | the name for the containing frame |
| addItem (name, | attaches a menu item to a parent item and |
| image, text, | returns the new menu item reference, where |
| sText, visible, | name equals a unique name of the menu |
| URL, target, eval) | item, image equals an image attached to |
| | (associated with) the menu item, text |
| | equals the default text of the menu item, |
| | sText equals text to be displayed in a |
| | status line during mouseover, visible |
| | equals a Boolean value indicating |
| | visibility, URL (optionally) equals a URL |
| | to be loaded in the workspace frame when a |
| | menu item is clicked, target (optionally) |
| | equals a target frame name for a click |
| | action, and eval (optionally) equals a |
| | Boolean value indicating whether to |
| | produce a real URL when a menu item is |
| | clicked |
| setItemVisible | changes the visibility of a menu item |
| (visible) | |

Like the navigational manager 300, the frameset manager 302 includes two objects: a frame object 308 and a frameset object 310. The objects can 308 and 310 help the frameset manager 302 cache frames at the client 104.

The following table provides examples of properties and methods of the frame object 308:

| Property or Method | Description |
|---|---|
| bordercolor | indicates frame color border |
| frameborder | indicates border value |
| marginheight | indicates frame margin height |
| marginwidth | indicates frame margin width |
| scrolling | indicates frame scrolling |
| noresize | indicates frame noresize parameter |
| | (resizing allowable or not) |
| addFrames (type, | adds a frameset to a frame, where type |
| target) | equals “rows” or “columns” to indicate how |
| | frames are arranged in the frameset and |
| | target equals the name of containing |
| | frames if different from parent frame |
| set (frameborder, | sets named frame attributes |
| bordercolor, | |
| marginheight, | |
| marginwidth) | |
| setURL (URL, eval) | sets the URL to be loaded in frame, where |
| | eval equals a Boolean value indicating |
| | whether the URL is to be evaluated before |
| | the frame is loaded |

The following table provides examples of properties and methods of the frameset object 310:

| Property or Method | Description |
|---|---|
| bordercolor | indicates frameset color border |
| border | indicates border value |
| frameborder | indicates frameborder value |
| framespacing | indicates framespacing value |
| scrolling | indicates frame scrolling |
| noresize | indicates frame noresize parameter |
| addFrame (name, | adds a frame to a frameset, where name |
| size, URL, eval) | equals an application-wide unique frame |
| | name (null if page is empty), size equals |
| | size of frame in pixels or as a percentage |
| | (e.g., “*,” “50,” “20%,” etc.), URL equals |
| | the URL to load, and eval equals a Boolean |
| | value indicating whether to evaluate the |
| | URL |
| set (frameborder, | sets named frame attributes |
| bordercolor, | |
| border, | |
| framespacing) | |
| setOnload (onload, | sets onload event handler for the |
| eval) | frameset, where eval equals a Boolean |
| | value indicating whether to evaluate the |
| | URL before the frame is loaded |
| setup | recursively builds the frameset (upstream |
| | and downstream), recursively loads all |
| | included framesets (upstream and |
| | downstream), sets up any and all framesets |
| | included in any and all included frame, |
| | and loads parent frame if the containing |
| | frame is not currently displayed |

The properties and methods of the navigation object 304, the menu object 306, the frame object 308, and the frameset object 310 are not limited to the properties and methods included in their respective tables. Each of the objects 304, 306, 308, and 310 may include more or fewer properties and/or methods. Furthermore, each of the properties and methods may be alternatively implemented, e.g., using a zero/one toggle bit instead of a Boolean value.

The remaining figures and accompanying discussion describes an example of how the navigation mechanism 102 functions in the context of the client 104 requesting a web page from the server 106.

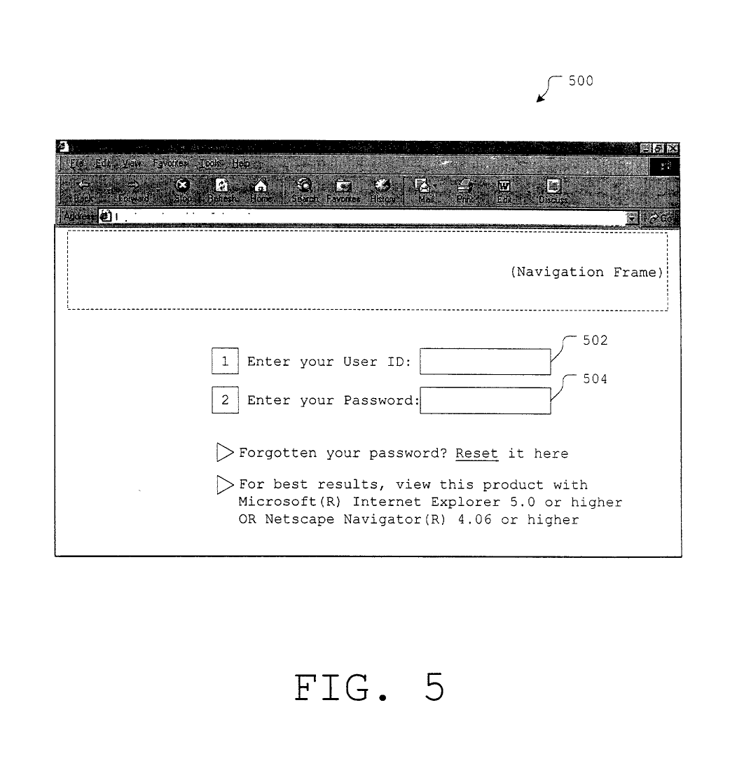

Referring to FIG. 5, when a user at the client 104 requests access to the applications 120 at the server 106, the server 106 returns a login screen 500 to the client 104. The user logs in with the server 106 through the login screen 500. Requiring the user to log in with the server 106 can enable the server 106 to track users of the applications 120, to verify the identity of the user, to restrict access to some or all secure information included in the applications 120, or to satisfy another similar purpose. The user enters in a user identification code, name, number, or other similar identifier in an identification box 502 and a password or other similar security code in a password box 504. A password may not be required. For instance, the server 106 may use some other security technique such as electronic verification, e.g., with a digital certificate or watermark. Note also that a login screen may not be necessary to access the applications 120, in which case the client 104 would receive another page in response to a request for the applications 120.

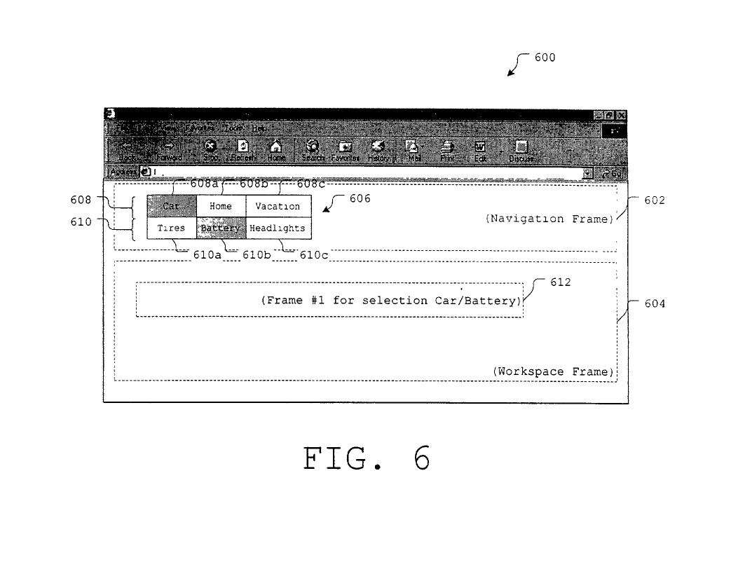

Referring to FIG. 6, after logging in (if necessary), the client 104 receives a first web page 600. The first web page 600 includes a navigation frame 602 and a workspace frame 604, similar, respectively, to the navigation frame 202 and the workspace frame 204 (see FIG. 2). The navigation frame 602 on the first web page 600 includes two levels of menu options 606: top-level menu options 608 and second-level menu options 610. The top-level menu options 608 include three options: a car option 608a, a home option 608b, and a vacation option 608c. The options that show in the second-level menu options 610 depend on which top-level menu option is selected. Here, the car option 608a is selected (shown as shaded). Thus, the shown second-level menu options 610 reflect options related to the car option 608a: a tires option 610a, a battery option 610b, and a headlights option 610c. Here, the battery option 610b is selected (shown as shaded).

The workspace frame 604 includes one or more frames related to the selected menu options 606. Here, only one frame 612 is displayed for the selected car option 608a and the selected battery option 610b.

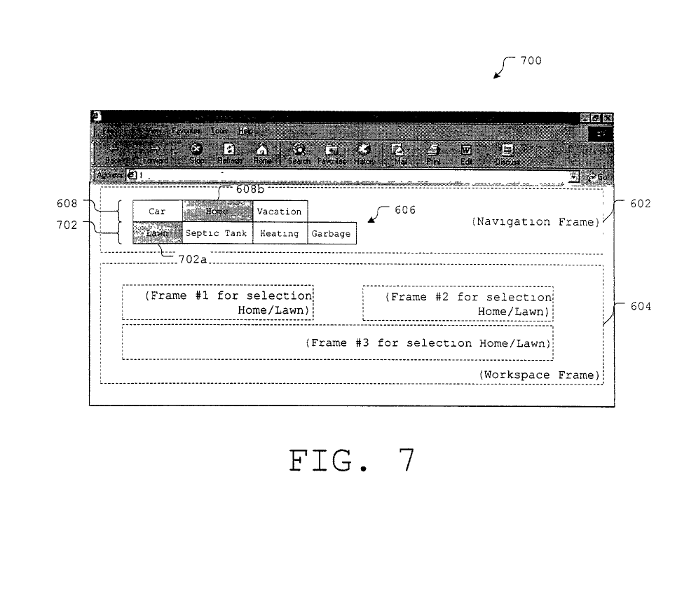

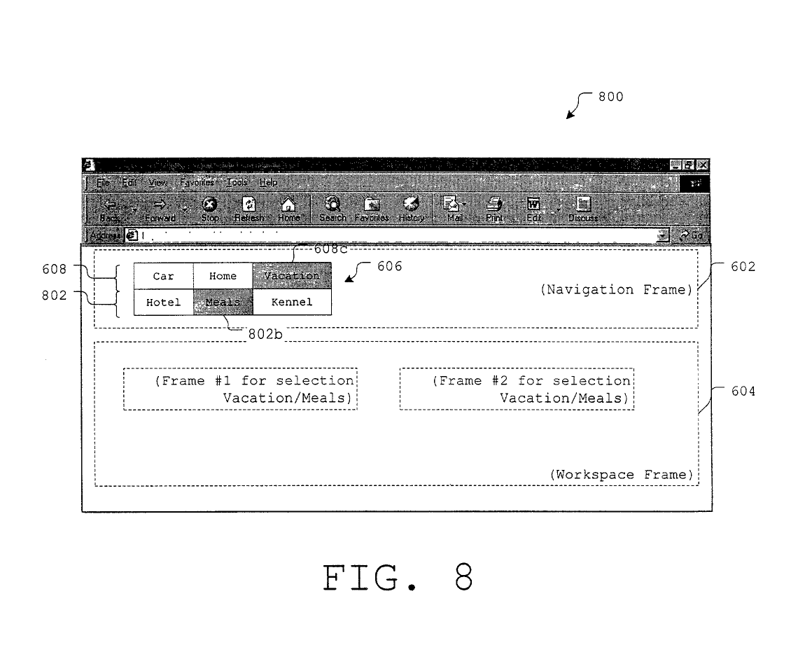

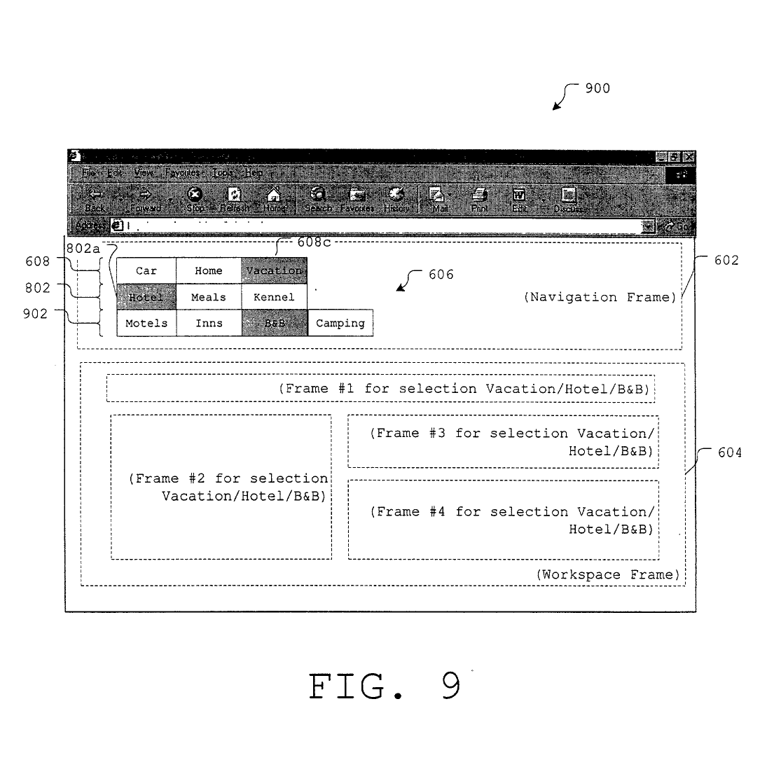

The car option 608a and the battery option 610b are the default selected options 606 when the client 104 receives the first web page 600. The default selected options, however, could be any (one or more) of the menu options 606. For example, an alternate first web page 700 could have the home option 608b selected along with a home-related second-level option 702, such as a lawn option 702a as shown in FIG. 7. In another alternate first web page 800, the vacation option 608c may be selected along with a vacation-related second-level option 802, such as meals option 802b, as shown in FIG. 8. In yet another alternate first web page 900, the vacation option 608c and a hotel second-level option 802a are selected along with a third-level vacation/hotel-related option 902, such as a bed and breakfast option 902a.

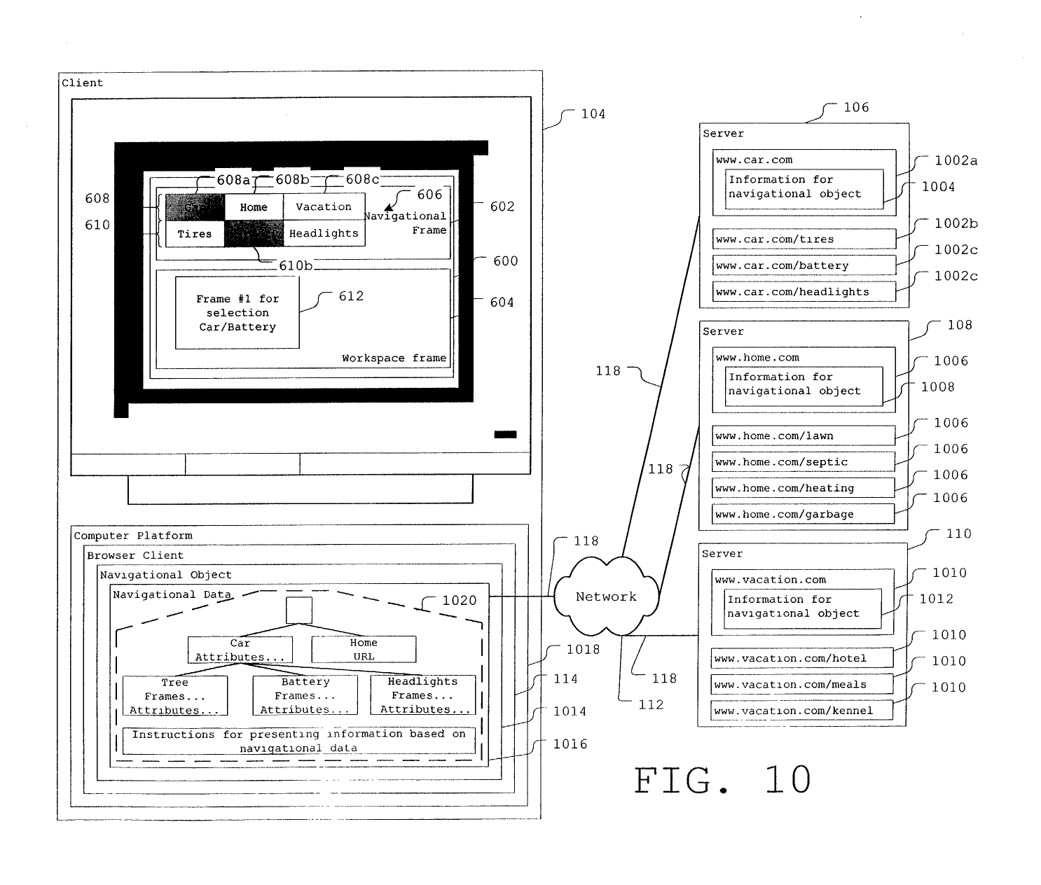

Referring to FIG. 10, the browser 114 displays the first web page 600 (or other default first web page) on a client display 1000. The browser 114 also displays all other web pages on the client display 1000. The client display 1000 can include any screen or panel capable of displaying network information, such as a computer monitor, a television, a personal digital assistant screen, a telephone display panel, a watch display panel, a pager display panel, or other similar display mechanism.

Assume in this example that each of the servers 106, 108, and 110 hosts data and/or instructions for at least one of the menu options 606. The first server 106 includes data and information 1002 to populate the workspace frame 604 for the car option 608a corresponding to the World Wide Web URL car.com and for each of the car-related options 610. The first server 106 also includes navigational data and information 1004 for the car option 608a. The second server 108 includes workspace data and information 1006 and navigational data and information 1008 for the home option 608b. Similarly, the third server 110 includes workspace data and information 1010 and navigational data and information 1012 for the vacation option 608c. When the user selects a combination of the menu options 606, the appropriate data and/or instructions are sent across the network 112 to the client 114 from the appropriate server 106, 108, or 110.

In receiving the first web page 600, the client receives a navigational object 1014 and navigational data 1016 related to the first web page 600. For the first web page 600, the navigational data 1016 comes from the car navigational object information 1002a and the car/battery information 1002b at the first server 106. Note that the navigational object 1014 and the navigational data 1016 are included in the browser 114, which in turn is part of the client's platform 1018.

The navigational data 1016 includes a hierarchical database 1020 including the data and information from the servers 106, 108, and 110. The navigational data 1016 also includes instructions 1022 for presenting information based on data and information included in the hierarchical database 1020, e.g., colors, sizes, etc.

The web display pages discussed above are not limited to any particular layout or configuration. For example, manipulation tools such as pulldown menus, tabs, buttons, selection boxes, and scrollbars can be implemented using any similar type of manipulation tool. In another example, frames such as the navigation frame, the workspace frame, and the frames included in the workspace frame can be located anywhere on a screen and be of any size.

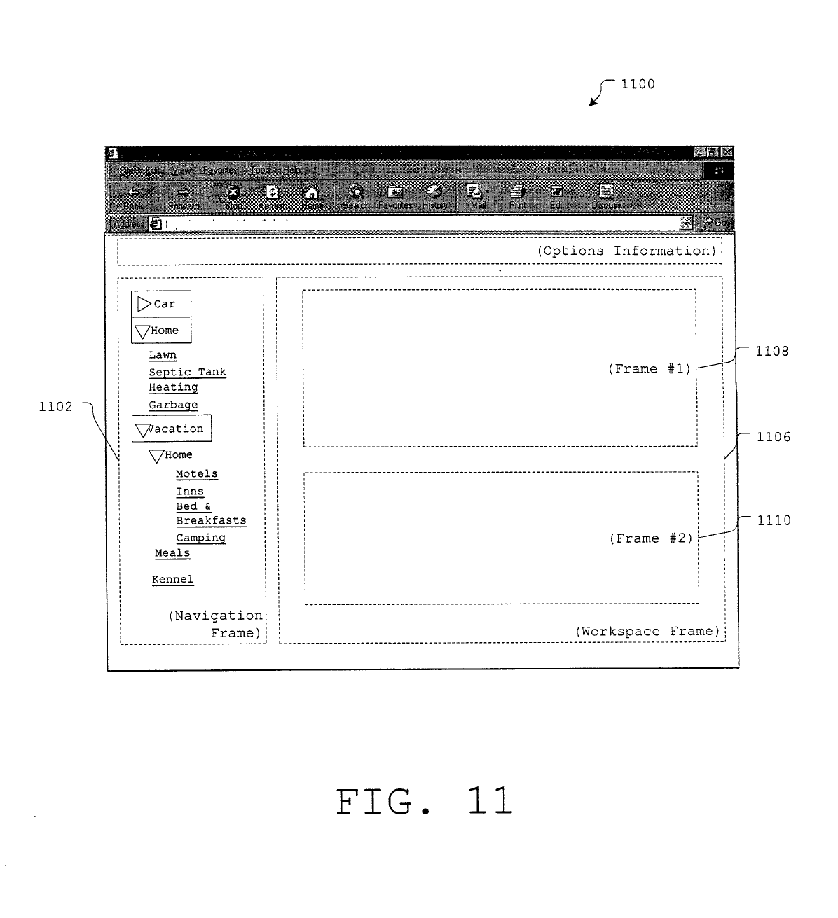

In another example, referring to FIG. 11, a navigational object sent to a client can be used to “abstract” navigational structure so that just by changing a small amount of the code or instructions sent to the client, the entire look and feel of a web page 1100 can change. A navigation frame 1102 including menu options 1104 corresponds to the navigation frame 202 including menu options 206 (see FIG. 2). The left-most menu options 1104 are the top-level menu options, with each subsequent menu option level indented to the right. Similarly, a workspace frame 1106 including frames 1108 and 1110 corresponds to the workspace frame 204 and the frames 208 and 210. (Of course, the frames in FIG. 11 include different information than their correspondents in FIG. 2.)

The techniques described here are not limited to any particular hardware or software configuration; they may find applicability in any computing or processing environment. The techniques may be implemented in hardware, software, or a combination of the two. The techniques may be implemented in programs executing on programmable machines such as mobile or stationary computers, personal digital assistants, and similar devices that each include a processor, a storage medium readable by the processor (including volatile and non-volatile memory and/or storage elements), at least one input device, and one or more output devices. Program code is applied to data entered using the input device to perform the functions described and to generate output information. The output information is applied to one or more output devices.

Each program may be implemented in a high level procedural or object oriented programming language to communicate with a machine system such as Java, JavaScipt, Jscript, Visual Basic Scripting Edition (VBScript), Practical Extension and Report Language (PERL), Python, Unified Modeling Language (UML), Eiffel, Smalltalk, HTML, C, or other interpreted or executable instructions. In the case of object oriented programming, the object may not be an “object” in the strict object oriented sense but may instead be a combination of non-objected instructions and data structure(s). However, the programs can be implemented in assembly or machine language, if desired. In any case, the language may be a compiled or interpreted language.

Each such program may be stored on a storage medium or device, e.g., compact disc read only memory (CD-ROM), hard disk, magnetic diskette, or similar medium or device, that is readable by a general or special purpose programmable machine for configuring and operating the machine when the storage medium or device is read by the computer to perform the procedures described in this document. The system may also be considered to be implemented as a machine-readable storage medium, configured with a program, where the storage medium so configured causes a machine to operate in a specific and predefined manner.

Other embodiments are within the scope of the following claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method comprising:
receiving page instructions for displaying a first web page, the page instructions including frame instructions for displaying an application on the first web page;
storing the application instructions;
receiving new page instructions for displaying a second web page;
determining if the second web page includes the application; and
formatting the second web page for display based on the new page instructions and, if the second web page includes the application, on the application instructions.

2. The method of claim 1 in which the application instructions include object-oriented instructions.

3. The method of claim 1 in which the page instructions include instructions in a Java-based language.

4. The method of claim 1 in which the new page instructions do not include data included in the application if the second web page includes the application.

5. The method of claim 1 in which the only instructions regarding the application that are included in the new page instructions include formatting instructions for the frame if the second web page includes the frame.

6. The method of claim 1 in which the application includes a frame.

7. An article comprising:
a machine-readable medium which stores machine-executable instructions, the instructions causing a machine to:
receive page instructions for displaying a first web page, the page instructions including frame instructions for displaying a frame on the first web page;
store the frame instructions;
receive new page instructions for displaying a second web page;
determine if the second web page includes the frame; and
format the second web page for display based on the new page instructions and, if the second web page includes the frame, on the frame instructions.

8. The article of claim 7 in which the frame instructions include object-oriented instructions.

9. The article of claim 7 in which the page instructions include instructions in a Java-based language.

10. The article of claim 7 in which the new page instructions do not include data included on the frame if the second web page includes the frame.

11. The article of claim 7 in which the only instructions regarding the frame that are included in the new page instructions include formatting instructions for the frame if the second web page includes the frame.

12. An apparatus comprising:
a first mechanism configured to store instructions regarding a frame included on a web page; and
a second mechanism configured to determine if another web page includes the frame, and if so, to format the other web page for display using the instructions.

13. The apparatus of claim 12 further comprising a second mechanism configured to display the web page.

14. The apparatus of claim 13 in which the second mechanism includes a web browser.

15. The apparatus of claim 12 in which the instructions include object-oriented instructions.

16. The apparatus of claim 12 in which the first mechanism includes computer memory.

17. The apparatus of claim 12 in which instructions sent from a location remote to the first mechanism instruct the first mechanism to store the instructions.

18. The apparatus of claim 12 further comprising a computer including the first mechanism and the second mechanism.

19. The apparatus of claim 12 in which the frame instructions include object-oriented instructions.

20. The apparatus of claim 12 in which the page instructions include instructions in a Java-based language.

21. An apparatus comprising:
a server configured to communicate with a network;
a first mechanism accessible by the server and configured to host page instructions regarding a first web page, the page instructions including data instructions regarding data included on the first web page and including frame instructions regarding a frame included on the first web page; and
a second mechanism accessible by the server and configured to host an application including the page instructions for transmission to a destination on the network.

22. The apparatus of claim 21 in which the frame instructions include modification instructions regarding how to modify the frame from stored instructions included at the destination.

23. The apparatus of claim 21 in which the page instructions include object-oriented instructions.

24. The apparatus of claim 21 in which the page instructions include instructions in a Java-based language.

25. The apparatus of claim 21 in which the network includes an Internet.

26. A system comprising:
a first device configured to communicate with a network;
a second device configured to communicate with the network;
a first mechanism configured to communicate with the second device and to host page instructions regarding a first web page hosted by the second device, the page instructions including frame instructions regarding a frame included on the first web page;
a second mechanism configured to communicate with the first device and to store the frame instructions;
a third device configured to communicate with the network and to host second page instructions regarding a second web page hosted by the third device, the second page instructions including second frame instructions regarding the frame; and
a third mechanism configured to communicate with the first device and to format the second web page using the frame instructions and the second frame instructions.

27. The system of claim 26 in which the only instructions regarding the frame that are included in the second frame instructions include alterations to be made to the frame instructions.

28. The system of claim 26 in which the frame instructions include object-oriented instructions.

29. The system of claim 26 in which the frame instructions include instructions in a Java-based language.

30. The system of claim 26 in which the first device includes a computer device.

31. The system of claim 26 in which the second device and the third device each include a server device.

32. The system of claim 26 in which the network includes an Internet.

33. A method comprising:
receiving page instructions from a first host, the page instructions including frame instructions regarding a frame included on a first web page;
storing the frame instructions;
requesting a second web page from a second host associated with the first host;
receiving format instructions from the second host, the format instructions including instructions regarding a second web page;
determining if the second web page includes the frame; and
formatting the second web page using the format instructions and, if the second web page includes the frame, the frame instructions.

34. The method of claim 33 in which the page instructions also include data for the first web page.

35. The method of claim 33 in which the format instructions include data for the second web page.

36. The method of claim 33 in which the format instructions include new frame instructions regarding a new frame included on the second web page.

37. The method of claim 33 in which the format instructions include instructions regarding modifying the frame from the frame instructions.

38. The method of claim 33 further comprising requesting the first web page from the first host.

39. The method of claim 33 in which the first host and the second host each include a server device.

40. The method of claim 33 in which the frame instructions include object-oriented instructions.

41. The method of claim 33 in which the frame instructions include instructions in a Java-based language.

42. An article comprising:
a machine-readable medium which stores machine-executable instructions, the instructions causing a machine to:
receive page instructions from a first host, the page instructions including frame instructions regarding a frame included on a first web page;
store the frame instructions;
request a second web page from a second host associated with the first host;
receive format instructions from the second host, the format instructions including instructions regarding a second web page;
determine if the second web page includes the frame; and
format the second web page using the format instructions and, if the second web page includes the frame, the frame instructions.

43. The article of claim 42 in which the page instructions also include data for the first web page.

44. The article of claim 42 in which the format instructions include data for the second web page.

45. The article of claim 42 in which the format instructions include new frame instructions regarding a new frame included on the second web page.

46. The article of claim 42 in which the format instructions include instructions regarding modifying the frame from the frame instructions.

47. The article of claim 42 further causing a machine to request the first web page from the first host.

48. The article of claim 42 in which the first host and the second host each include a server device.

49. The article of claim 42 in which the frame instructions include object-oriented instructions.

50. The article of claim 42 in which the frame instructions include instructions in a Java-based language.
